(19) United States
(12) Patent Application Publication
(10) Pub. No.: US 2004/0003727 A1
(43) Pub. Date: Jan. 8, 2004

(54) Electrical food warming apparatus

(76) Inventor: Kevin Ronald McWilliams, Stratford upon Avon (GB)

Correspondence Address: Ira S. Dorman, Suite 200, 330 Roberts Street, East Hartford, CT, 06108, US

(21) Appl. No.: 10/456,812

(22) Filed: Jun. 5, 2003

(30) Foreign Application Priority Data
Jun. 7, 2002 (GB) 0213081.3

(51) Int. Cl. A23L 1/00; A47J 27/62

(52) U.S. Cl. 99/483; 99/331

(57) ABSTRACT

An electrical food warming apparatus (1) comprising: an electrically insulating plate (3) providing a cooking surface for supporting a utensil, a layer of dielectric material (5) arranged below the electrically insulating plate (3), at least one elongate electrical resistance heating element (11) wound around the dielectric layer (5), and means for supporting the dielectric layer (5), and the at least one heating element (11) thereon, such that at least a part of the at least one heating element (11) is maintained in direct contact with the underside of the electrically insulating plate (3).

### FIELD OF THE INVENTION

This invention relates to an electrical food warming apparatus which may be used, for example, in combination with a glass-ceramic cooking surface.

### DESCRIPTION OF PRIOR ART

Electrical food warming apparatus is employed to heat a surface which supports utensils containing food or the like to a relatively low temperature or to maintain the food at a relatively low temperature, but such apparatus is not employed to cook the food in the utensil. Consequently, such surface heating apparatus requires only a relatively low power loading, generally less than 0.5 watts per square centimetre, to achieve satisfactory surface temperatures.

Currently a variety of heat sources are used in electrical food warming apparatus, including sheathed elements with reflectors and low wattage radiant heaters. These heat sources, however, are arranged with an air gap between the heating element and the undersurface of the heated surface. This air gap acts as both an electrical and thermal insulation layer and so reduces the thermal efficiency of the apparatus.

Conventional radiant heaters for glass-ceramic or like appliances can also be used to generate low temperatures which are suitable for warming. However the heater is also used as a full power heater and high cooking surface temperatures are therefore also generated for cooking, rather than just warming by this form of heater arrangement. At high temperatures the electrical resistance of the glass-ceramic is reduced significantly and electrical insulation materials are required between the electrical heating element and the glass-ceramic material.

The use of electrical insulation material slows the heat transfer to the glass-ceramic surface and any utensil thereon. This slow heat transfer reduces the thermal performance of the apparatus.

To improve thermal performance in electrical food warming apparatus, there is a need for a means of generating a warming zone on a surface, such as glass-ceramic, while safely employing low wattage electrical heating elements in direct contact with the underside of the warming surface. One method of constructing an appliance with a warming zone uses metal foil heating elements bonded to a glass-ceramic surface. However, this is not a sufficiently simple or cost effective means of construction.

### OBJECT OF THE INVENTION

It is therefore an object of the present invention to provide an electrical food warming apparatus which overcomes or reduces the above problems.

### SUMMARY OF THE INVENTION

According to the present invention there is provided an electrical food warming apparatus comprising: an electrically insulating plate providing a cooking surface for supporting a utensil, a layer of dielectric material arranged below the electrically insulating plate, at least one elongate electrical resistance heating element wound around the dielectric layer, and means for supporting the dielectric layer, and the at least one heating element thereon, such that at least a part of the at least one heating element is maintained in direct contact with the underside of the electrically insulating plate.

The electrically insulating plate may comprise a glass material, preferably a glass-ceramic material.

The dielectric layer may be in the form of a sheet and may comprise a mica material.

The at least one elongate electrical resistance element may be of wire or ribbon form.

The support means may be a dish-like support, for example of metal.

The dish-like support may have a heat reflective inner surface.

The dish-like support may contain a layer of thermal insulation material, preferably microporous thermal insulation material.

A thermostat, preferably a disc-type thermostat, may be mounted to the underside of the dielectric layer. The thermostat may be used to control a warning light.

For a better understanding of the invention and to show more clearly how it may be carried into effect, reference will now be made, by way of example, to the accompanying drawings in which:

### BRIEF DESCRIPTION OF THE DRAWINGS

FIG. 1 is a cross-sectional view of an embodiment of an electrical food warming apparatus according to the present invention;

FIG. 2 is a plan view of a heating element wound around a dielectric layer forming part of the electrical food warming apparatus shown in FIG. 1;

FIG. 3 is a cross-sectional view of another embodiment of an electrical food warming apparatus according to the present invention incorporating a thermal insulation layer;

FIG. 4 is a perspective view of the underside of a modification of the element and dielectric layer arrangement of FIG. 2 showing the presence of a thermostat; and

FIG. 5 is a cross-sectional view of an electrical food warming apparatus according to the present invention showing the position of the thermostat in relation to a food warming surface of the apparatus.

### DESCRIPTION OF PREFERRED EMBODIMENTS

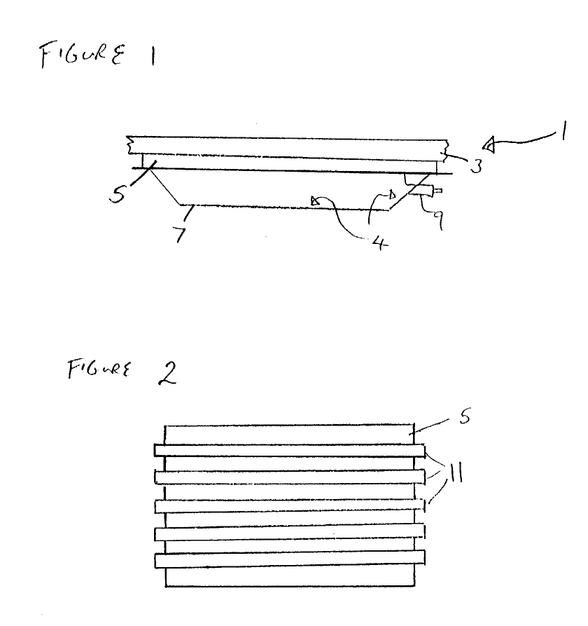

Referring to FIGS. 1 and 2, an electrical food warming apparatus 1 comprises an elongate electrical resistance heating element 11 wound around a sheet-like layer of dielectric material 5. The dielectric layer 5, and heating element 11 thereon, is maintained in direct contact with the underside of an electrically insulating warming surface in the form of a glass-ceramic plate 3 of infrared transmissive material by means of a dish-like support 7.

The elongate electrical resistance element 11 is of a form which facilitates winding around the layer of dielectric material 5, for example wire or ribbon form. This construction enables a heater arrangement to be manufactured quickly and cost effectively.

The sheet-like layer of dielectric material 5, for example mica, provides a relatively rigid electrically non-conductive base for the wound heating element 11 and insulates the dish-like support 7 from the element 11 when the dish-like support 7 holds the dielectric material in firm contact against the undersurface of the glass-ceramic plate 3.

Contact between the heating element 11 and the undersurface of the glass-ceramic plate 3 is maintained by biasing means (not shown) holding the dish-like support in position relative to the undersurface of the glass-ceramic plate 3. Such biasing means is well known to the person skilled in the art of glass-ceramic cooking appliances.

The surface finish of the inner surface 4 of the base and sides of the dish-like support 7 is highly reflective to act as a directional heat reflector. The presence of the reflective surface 4 reduces the heat lost by radiation from the apparatus through the support 7 and increases the heat transmitted to the glass-ceramic plate 3.

An end region of the heating element 11 extends through an aperture in the dish-like support 7 and a terminal 9 is provided for connecting the heating element 11 to a power supply (not shown).

As described hereinabove, to create a warming zone for a glass-ceramic appliance, only a relatively low power loading, less than 0.5 watts per square centimetre, is required to achieve acceptable glass-ceramic surface temperatures.

Consequently, only a low wattage is generated by the assembly of the heating element 11 around the dielectric layer 5. It is therefore safe for the heating element 11 to be placed in direct contact with the undersurface of the glass-ceramic plate 3, as the temperature of the glass-ceramic material in use will be low, maintaining the high electrical resistivity of the glass-ceramic material.

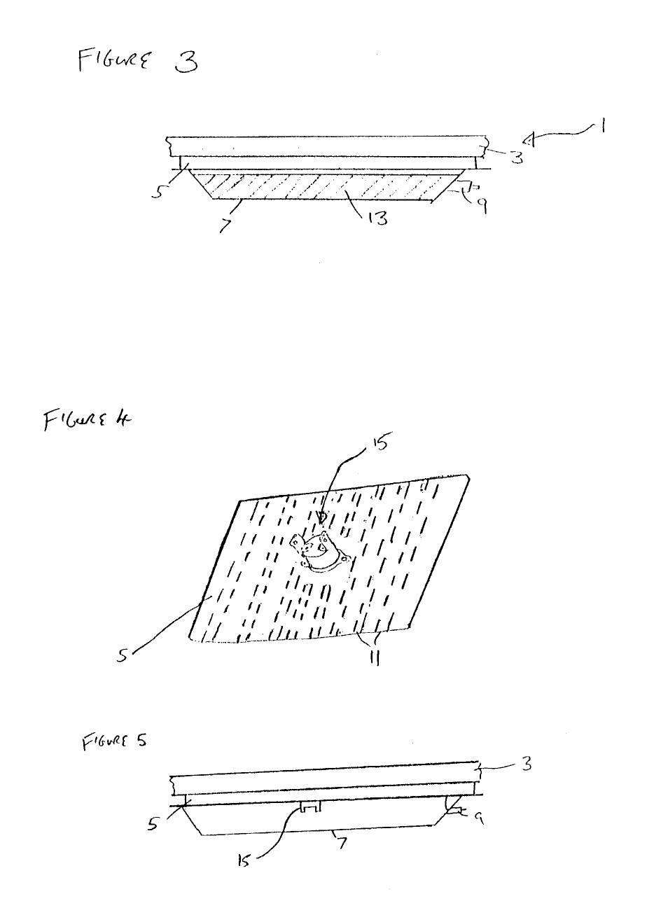

FIG. 3 shows a second embodiment of an electrical food warming apparatus 1 comprising an elongate electrical resistance heating element 11 wound around a sheet-like layer of dielectric material 5. The dielectric layer 5, and heating element 11 thereon, is maintained in direct contact with the underside of a glass-ceramic plate 3 by means of a dish-like support 7. The dish-like support 7 contains a layer of thermal insulation material 13, preferably compacted microporous thermal insulation material.

Such microporous thermal insulation material is known by a person skilled in the art and typically comprises a highly dispersed metal oxide powder, such as silica aerogel or pyrogenic silica, mixed with glass filament or ceramic fibre reinforcement, an opacifier such as titanium dioxide, and an optional small quantity of alumina powder to resist shrinkage.

Referring to FIGS. 4 and 5, an electrical food warming apparatus 1 is shown with a disc-type thermostat 15 attached to the underside of the sheet-like layer of dielectric material 5, between adjacent turns of the heating element 11.

The disc-type thermostat 15 is positioned in order that it can sense the temperature of the glass-ceramic plate 3. The temperature sensed by the thermostat 15 can be used to activate a warning light (not shown) to inform a user when the glass-ceramic plate 3 is considered too hot to be touched.

Although FIG. 5 shows the disc-type thermostat 15 in relation to the dish-like support, without the presence of thermal insulation 13, it should be appreciated that it could also be used in an electrical food warming apparatus 1, as shown in FIG. 3, which utilises thermal insulation 13.

I claim:

1. An electrical food warming apparatus comprising: an electrically insulating plate providing a cooking surface for supporting a utensil, a layer of dielectric material arranged below the electrically insulating plate, at least one elongate electrical resistance heating element wound around the dielectric layer, and means for supporting the dielectric layer, and the at least one heating element thereon, such that at least a part of the at least one heating element is maintained in direct contact with the underside of the electrically insulating plate.

2. The apparatus of claim 1, wherein the electrically insulating plate comprises a glass material.

3. The apparatus of claim 2, wherein the glass material comprises a glass-ceramic material.

4. The apparatus of claim 1, wherein the dielectric layer is in the form of a sheet.

5. The apparatus of claim 1, wherein the dielectric layer comprises a mica material.

6. The apparatus of claim 1, wherein the at least one elongate electrical resistance element is selected from wire and ribbon form.

7. The apparatus of claim 1, wherein the support means comprises a dish-like support.

8. The apparatus of claim 7, wherein the dish-like support comprises a metal dish-like support.

9. The apparatus of claim 7, wherein the dish-like support has a heat reflective inner surface.

10. The apparatus of claim 7, wherein the dish-like support contains a layer of thermal insulation material.

11. The apparatus of claim 10, wherein the thermal insulation material comprises microporous thermal insulation material.

12. The apparatus of claim 1, wherein a thermostat is mounted to the underside of the dielectric layer.

13. The apparatus of claim 12, wherein the thermostat comprises a disc-type thermostat.

14. The apparatus of claim 12, wherein the thermostat is adapted to control a warning light.
